(19) United States
(12) Patent Application Publication
(10) Pub. No.: US 2014/0091608 A1
(43) Pub. Date: Apr. 3, 2014

(54) ONE PIECE CHAIR WITH INTEGRAL ARM REST

(71) Applicant: Barbara SCHOENENBERGER, Hempstead, NY (US)

(72) Inventor: Barbara SCHOENENBERGER, Hempstead, NY (US)

(21) Appl. No.: 13/630,521

(22) Filed: Sep. 28, 2012

(51) Int. Cl. A47C 7/54; B27M 3/18; B21D 35/00

(52) U.S. Cl. CPC A47C 7/54; B21D 35/00; B27M 3/18
USPC 297/411.2; 72/324; 144/360; 156/211

(57) ABSTRACT

A chair and method of construction with the chair being comprised of a single flat sheet of a bendable material capable of supporting a human body. A longitudinal slit extends between the upper and lower edges and is spaced from the upper edge. The slit is offset from an adjacent side edge wherein the slit separates portions of the sheet into a large area portion and a small area portion. The large area portion is bent with alternating bends, to provide a chair configuration with support of a back, hips, thighs, and knees of a person seated thereon. The small area portion of the sheet is bent with alternating bends to provide an armrest support for the person seated on the chair. The chair is directly supported on the ground at the bend configured for supporting the hips and at the lower edge of the sheet, without any separate leg elements.

### FIELD OF THE INVENTION

This invention relates to arm chairs with integral armrests and particularly to lounge type chairs having both leg and arm supports.

### BACKGROUND

Chairs generally fall into the categories of lounge chairs with foot support or rests and chairs without such foot support or rests for upright seating such as against tables and desks. In addition, chairs are available, with or without separate arm supports, or rests or with single side arm rests. Nearly all lounge chairs with foot support or rests and with arm rest(s) are comprised of many interconnected components and are relatively difficult to construct or entail relatively high costs for construction. Even chairs with integral elements are expensive since they often require specialized molds, and costly construction processing, particularly for chairs made of hard plastic, or pre-shaped materials such as used in metal and wooden chairs.

### SUMMARY OF THE INVENTION

It is accordingly an object of the present invention to provide a stylistic and economical lounge type chair with an integrated foot support and with one or two integral arm rests, and made of inexpensive sheet metal, wood or similar bendable supportive material, with minimal construction processing.

It is a further object of the present invention to provide such lounge chair with a comfortable and stable structure conformed to human body support, with one or two simple material slits in an original flat sheet of a supportive but resilient material such as steel or aluminum or any metal or even processed woods or plastics. Several alternating bends of the material serve to configure a chair support structure with leg support and arm rest(s).

Generally, the present invention comprises a lounge type chair constructed of a single flat sheet of a material such as a bendable, structurally supportive sheet of metal, wood, plastic, and the like, capable of supporting a human body without deformation. Preferably, the material, such as aluminum, or wood laths, is of a dimension and configuration to provide a resilient spring-like support for a person seated on the chair. The present invention further encompasses a method for constructing the chair.

The chair is comprised of a single flat generally four sided and preferably rectangular or square sheet (hereinafter referred to as “rectangular”) of a bendable material capable of supporting a human body. The sheet comprises upper and lower edges and two side edges, with at least one longitudinal slit extending between the upper and lower edges and spaced from the upper edge. The slit is offset from an adjacent side edge and extends preferably parallel thereto wherein the slit separates portions of the sheet into a large area portion and a small area portion. The large area portion is bent with alternating bends, which bends are configured to provide a chair configuration with sections of the large area portion being configured thereby to support a back, torso and legs of a person seated thereon. The small area portion of the sheet is bent with alternating bends to provide an armrest support for the person seated on the chair. The chair is directly supported on the ground at the bend configured for supporting the torso and at the lower edge of the sheet, without any separate leg elements.

The present invention encompasses a method for constructing the aforementioned chair from a single flat sheet comprising the steps of:
1) forming a sheet of a bendable supportive material with a longitudinal slit substantially parallel to an edge of the sheet and spaced therefrom, to delineate a large area of the sheet and a small area of the sheet;
2) forming bends in the large area of the sheet at separate positions wherein the back, torso and legs of the person seated on the large area of the sheet are configured to be supported;
3) forming bends in the small area of the sheet at a position configured to form an arm rest for an arm of the seated person.

The above objects features and advantages of the present invention will be further clarified by the following discussion and drawings in which:

### SHORT DESCRIPTION OF THE DRAWINGS

FIG. 1 is a right side front isometric view of an embodiment of a chair of the present invention;

FIG. 2 is a right side rear isometric view of the chair shown in FIG. 1;

FIG. 3 is a right side view of the chair of FIGS. 1 and 2.

FIG. 4 depicts an initial material sheet is a relatively square configuration with an initial right hand side slit extending through a lower end thereof;

FIGS. 5 depicts a material sheet as in FIG. 4 with an initial left hand side slit with material remaining at both ends thereof;

FIGS. 6 and 7 are top and bottom views respectively of an elongated rectangular flat sheet material with a slit, with material remaining at both ends thereof, used in the formation of the chair of FIGS. 1-3.

### DETAILED DESCRIPTION OF THE INVENTION

The sheet used to construct the chair is configured initially as a single flat sheet in preferably a four sided or generally rectangular configuration, though other regular shapes having upper and lower edges and lateral sides are also utilizable. The sheet is provided with one or two longitudinal slits, each offset from the respective adjacent longitudinal edge by a relatively small distance and the slit extending generally parallel to the edge. Each slit extends from an initial position at a small offset distance or spacing from a top width edge to a bottom width edge. Preferably, the slit does not effect a complete separation at the bottom width edge but terminates at a short distance from the bottom width edge. In order to comfortably accommodate the height and width of most users, the sheet is preferably at least 2 feet wide and 6 feet long.

The slitted sheet is generally alternately bent to form the chair configuration. The main and central body of the sheet or large area portion, extending inwardly from the slit(s), is bent at three positions and preferably four positions generally corresponding to the anatomical positions of a person's body at the knees, the thighs (providing a support area) the hips and the back. Support for the knees and the hips (and the thighs therebetween) is directly provided by ground contact of the bent sheet. Support for the back is provided by a resilient cantilever effect. The length of the sheet from the hip section bend is greater than the length of the sheet from the hip section bend to the top with the hip section bend being configured to provide a stable structure in a normal seating position, which is not susceptible to rearward tipping.

The slitted flat sheet is provided with an upward bend at the supportive position of the knees of a person in a seated/reclining (lounging) position, with the legs and feet of the seated person extending on one side of the upward bend and the thighs to the hips of the seated person on the other side. A slight contour bend between a bend at the hip position and the bend at the knee position provides an overall two-position bend, with an elevated support for the thighs. Another optional inward or upward shallow bend is configured to provide lumbar support to the lower back of the seated person.

The outer edge of the slitted sheet is correspondingly bent with alternating bends to provide an armrest for the seated person (two arm rests, if the sheet has the slit at both sides). The offset distance of the slit from the respective edge is of a dimension sufficient to comfortably support a human arm. A first bend of the outer edge from the top of the sheet is a downward shallow bend to accommodate the elbow of the seated person. The second bend is a forward or upward acute bend, spaced from the first bend for a distance sufficient to support the forearm of the seated person. The third bend is a rearward or downward acute bend sufficient to provide a supportive resilient base support for the arm with a Z configuration. The base or lower portion of the outer edge is preferably supported by integral connection to the sheet beyond the termination of the slit. Alternatively, the lower end at the slitted edge, separated at that point from the sheet, is supported by the ground.

The method of the present invention for construction of a lounge type chair comprises the steps of:
a) forming a substantially rectangular sheet of a bendable supportive material, capable of freely supporting a person, with at least one longitudinal slit in the sheet substantially parallel to an edge of the sheet and spaced therefrom by a distance sufficient to freely support a person's arm, with the slit extending for a substantial length across the sheet to delineate a large area of the sheet suitable to support a body of a person thereon from a small area of the sheet suitable to support the person's arm thereon;
b) forming a first upwardly extending bend in the large area of the sheet at a position wherein a knee of the person seated on the large area of the sheet is configured to be supported;
c) forming a second downwardly extending bend in the large area of the sheet at a position wherein the hips of the person seated on the large area of the sheet is configured to supported with a continued contoured bend between the bend at the knee position and the bend at the hip position to provide an upwardly directed thigh support segment for the person seated on the large area of the sheet;
d) optionally forming a third upwardly extending bend in the large area of the sheet at a position configured to provide lumbar support of the person seated on the large area of the sheet;
e) forming a first downwardly extending bend in the small area of the sheet at a position configured to provide support for the elbow of the person seated on the large area of the sheet;
f) forming a second upwardly and forwardly extending bend in the small area of the sheet at a distance from the first bend in the small area of the sheet sufficient to provide a support for a forearm of the person seated on the large area of the sheet; and
g) forming a third downwardly and rearwardly extending bend in the small area of the sheet to provide a configured Z shaped base support for the support of the forearm.

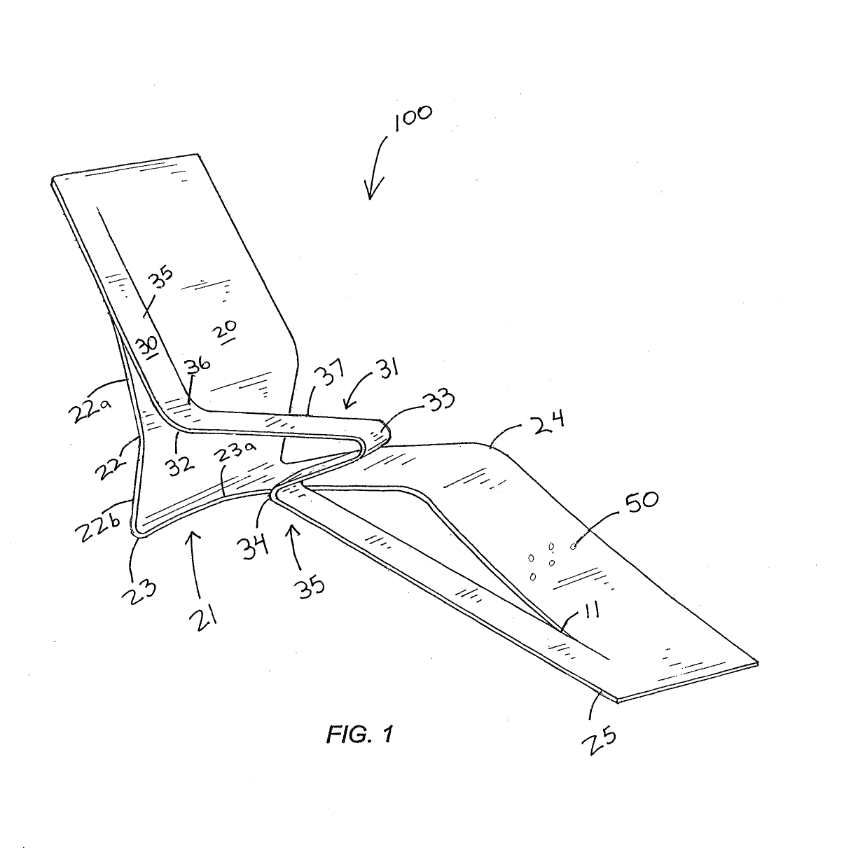

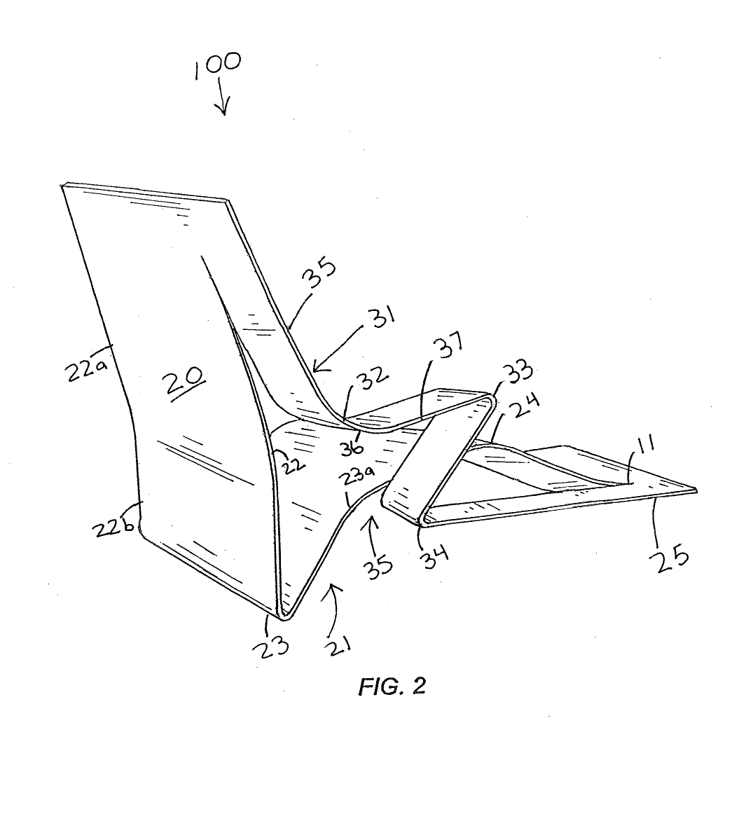

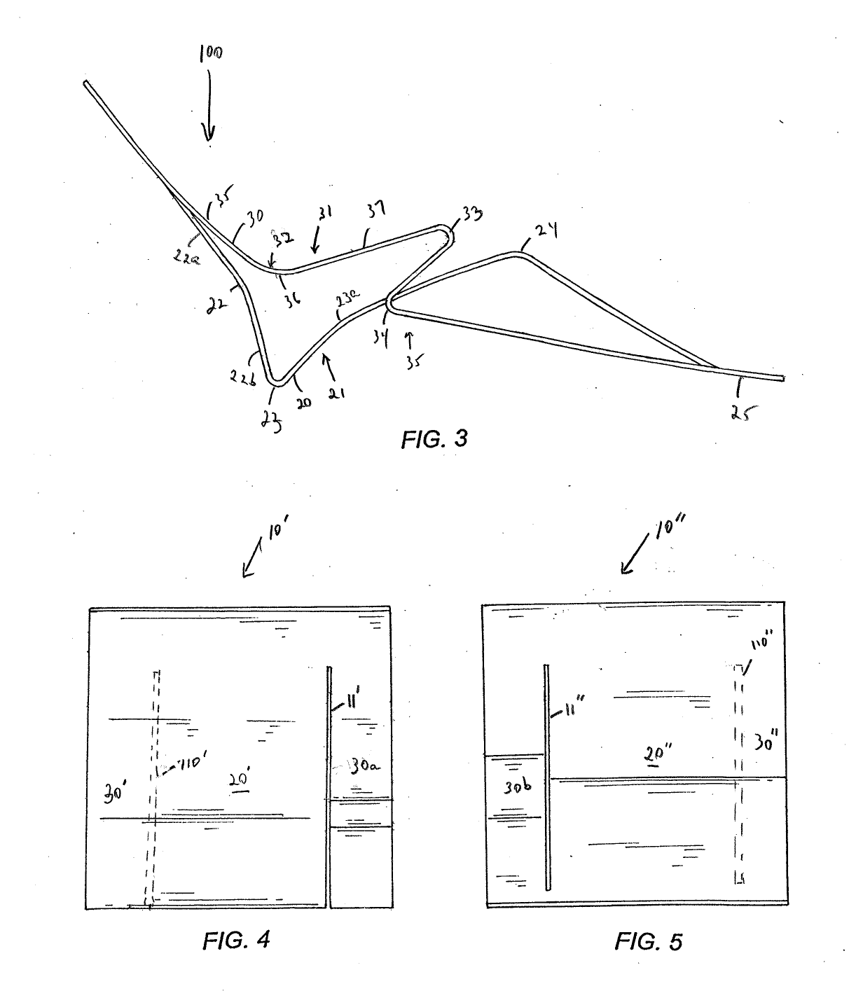

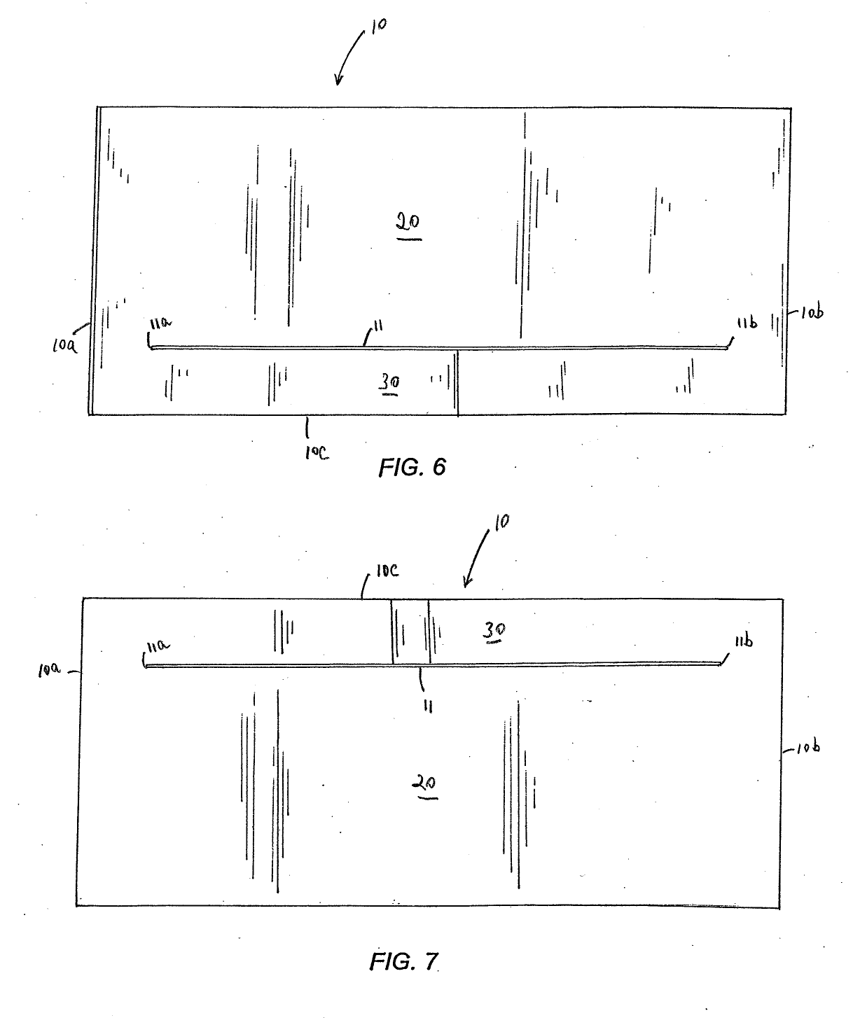

With reference to the drawings, the flat sheet 10 shown in FIGS. 6 and 7 is provided with a slit 11 spaced from sheet edges 10a and 10b respectively, and having ends 11a and 11b. The slit 11 is generally parallel to sheet edge 10c and separates, with demarcation, large sheet area 20 and small sheet area 30. The large sheet area 20 and the small sheet area are respectively bent, as shown in FIGS. 1-3, to provide a chair 100, with seating section 21 formed from large area 20 and arm rest section 31 formed from small area 30.

The flat sheet materials 10′ and 10″ of FIGS. 4 and 5 having slits 11′ and 11″ respectively, are wider than those shown in FIGS. 6 and 7. Accordingly, they may optionally be further slit, as shown by slits 110′ and 110″, depicted with dotted lines, to provide a second small area 30′ and 31″ for similar configuration into a second arm rest. The initially wider configuration provides sufficient accommodating seating area in large areas 20′ and 20″ respectively with the dual arm rests.

As shown in the chair embodiment of FIGS. 1-3, the flat sheet of FIG. 6 or 7 is alternately bent in the large sheet area 20 at positions 22, 23 23a and 24. Bend 22 is in a direction, which is upward from the original sheet and forward in the chair configuration shown. Bend 22 is a gentle one sufficient to provide a backrest section 22a and a lumbar support section 22b. Acute bend 23 extends downwardly and is configured to support the hips of a seated person. Gentle contour bend 23a and more acute bend 24 are generally upwardly directed and respectively serve to provide support for the thighs and knees of the seated person. The connection area 25 at the base of the sheet 10 and termination of the slit 11 serves as a front support for the chair 100 and the bend 23 serves as a rear support for the chair 100 with a low center of gravity and a stably supported structure.

The flat sheet 10 shown in FIGS. 6 and 7 may be configured as shown in FIGS. 1-3 to respectively provide chairs 100 with either right or left hand support arm rests.

The arm rest 31 in FIGS. 1-3 is shown as being on the right hand side as being configured from flat sheet 10 as positioned in FIG. 6 and a mirror image arm rest for the left hand side is configurable from the flat sheet 10 as positioned in FIG. 7. Dual armrests are configurable from the flat sheets 10′ and 10″, shown in FIGS. 4 and 5.

The armrest 31, shown in FIGS. 1-3, is configured from the small area 30 and includes a first downward or rear facing bend 32. Bend 32 defines sloping area 35, which is configured to support the shoulder to elbow portion of an arm of a seated person, with the elbow being supported at the bend area 32. A second forward or upward acute bend 33 is spaced from bend 32 to provide forearm support section 37 for the seated person. Reverse acute bend 34, facing downward or rearward, serves to provide Z shaped spring support 35 which is held in position at connection junction area 25. With the embodiment shown in FIG. 4, there is no similar connection junction area and the support for the armrest made therefrom is fully provided by ground support.

As further illustrated in the drawings, the chair is supported on the ground at a first support formed by one of the bends, which is located below the seating portion, namely at the bend which is generally V-shaped with the pointed end of the V-shaped portion forming the first support. Also, as illustrated in FIG. 1, the sheet body can be provided with perforations 50, both for purposes of ventilation and to reduce the weight of the chair. These perforations 50 can be located throughout or at selected locations. The edges of the sheet metal can be buffed to avoid any sharp edges and the distal longitudinal ends can be reentrantly bent to create grasping surfaces or portions 52,54, by which the chair can be lifted, as well as rested on the ground adjacent the lower edge.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A chair made from a single, generally rectangular sheet body of a bendable material, the chair comprising:
upper and lower edges and two side edges of the sheet body,
at least one longitudinal slit extending between the upper and lower edges, the slit being spaced from the upper edge, and the slit being offset from an adjacent side edge and extending generally parallel thereto;
wherein the slit separates portions of the sheet body into a large area portion and a small area portion,
the large area portion including several bends configured to provide a chair configuration with a back rest, a seating portion and a leg support, and
wherein the small area portion includes bends so located as to form an arm rest for the person seated on the chair.

2. The chair of claim 1, wherein the chair is supported on the ground at a first support formed by one of the bends which is located below the seating portion.

3. The chair of claim 2, wherein the chair is supported on the ground at a second position located at or adjacent the lower edge of the large area portion.

4. The chair of claim 1, wherein the sheet body comprises a second longitudinal slit forming a second small area portion with its respective bends, the second small area portion being configured to form a second arm rest.

5. The chair of claim 1, wherein the chair is formed of one of steel sheet, aluminum sheet, laminated wood, and plastic sheet.

6. The chair of claim 1, wherein the upper edge is re-entrantly bent to form a grasping portion.

7. The chair of claim 1, wherein the lower edge is re-entrantly bent to form a floor support.

8. The chair of claim 1, wherein the side edges are rounded to avoid the chair having any sharp edges.

9. The chair of claim 2, wherein the chair includes a generally V-shaped portion with a pointed end of the V-shaped portion forming said first support.

10. The chair of claim 1, wherein the small area portion includes first, second and third bends, and the arm rest extends between the first and second bends.

11. The chair of claim 1, wherein the sheet metal is perforated, at the large area portion.

12. The chair of claim 1, wherein the sheet body has a width sufficient to create the large area portion wide enough to seat two persons.

13. A method for constructing the chair of claim 1, comprising the steps of:
forming a substantially rectangular sheet of a bendable supportive materials with a longitudinal slit substantially parallel to an edge of the sheet and spaced therefrom, to delineate a large area of the sheet and a small area of the sheet;
forming bends in the large area of the sheet at separate positions wherein knees, hips and thighs of the person seated on the large area of the sheet are configured to be supported; and
forming bends in the small area of the sheet at a position configured to provide an arm rest support for an arm of the seated person.

14. The method of claim 13, including forming the rectangular sheet with a second longitudinal slit to form a second small area of the sheet, and forming bends in the second small area of the sheet to provide a second arm rest support.

15. The method of claim 13, including forming the chair of one of steel sheet, aluminum sheet, laminated wood, and plastic sheet.

16. The method of claim 13, including forming the small area with first, second and third bends, so located that the arm rest extends betweens the first and second bends.

17. The method of claim 13, including forming the large area with a width sufficient to seat two persons.
